(19) United States
(12) Patent Application Publication
(10) Pub. No.: US 2025/0047033 A1
(43) Pub. Date: Feb. 6, 2025

(54) CABLE CONNECTOR COVER

(71) Applicant: REPUBLIC OF KOREA (NATIONAL INSTITUTE OF METEOROLOGICAL SCIENCES), Seogwipo-si (KR)

(72) Inventors: Sung Eun Hwang, Seogwipo-si (KR); Byeong Taek Kim, Seogwipo-si (KR); Young Tae Lee, Seogwipo-si (KR); So Ra In, Seogwipo-si (KR); Ki Hoon Kim, Seogwipo-si (KR)

(73) Assignee: REPUBLIC OF KOREA (NATIONAL INSTITUTE OF METEOROLOGICAL SCIENCES), Seogwipo-si (KR)

(21) Appl. No.: 18/755,642

(22) Filed: Jun. 26, 2024

(30) Foreign Application Priority Data
Aug. 2, 2023 (KR) 10-2023-0100936

(51) Int. Cl. H01R 13/52; H01R 13/60

(52) U.S. Cl. CPC H01R 13/5213; H01R 13/60

(57) ABSTRACT

Disclosed is a cable connector cover which accommodates a cable and a connector to protect the cable and the connector from an external environment. The cable connector cover includes a first cover; and a second cover having one sides hinge-connected to each other, and rotating around a hinge axis, and having a space accommodating a cable and a connector therein, and one side of the first cover and one side of the second cover include a first seat portion and a second seat portion having seat holes communicating with the outside and seated with the accommodated cable, respectively, and insides of the first cover and the second cover include a first blocking portion and a second blocking portion having blocking holes on which the accommodated cable is seated, respectively when the first cover and the second cover form the space accommodating the cable and the connector.

### CROSS-REFERENCE TO RELATED APPLICATIONS

This application claims the priority of Korean Patent Application No. 10-2023-0100936 filed on Aug. 2, 2023, in the Korean Intellectual Property Office, the disclosure of which is incorporated herein by reference.

### BACKGROUND

### Field

The present disclosure relates to a cable connector cover, and more particularly, to a cable connector cover that protects a cable and a connector from an external environment, such as corrosion by the rainwater and damage due to the bird by accommodating the cable and the connector.

### Description of the Related Art

In general, when testing, inspecting, and repairing weather observation equipment, while a cable of the observation equipment and a connector connected to an end of the cable are left at an observation site, and only a sensor unit is removed to conduct the tasks and work of the test, inspection and repair. At this time, the cable of the sensor is left at the observation site, and especially the damage to the connector frequently occurs.

Sensor testing, inspection and repair take several weeks to several months, which increases the possibility of breaking the cable and the connector as the existing installed cable and connector are left outdoors for a long time, and damages such as delayed observation and expensive cable replacement in case of damage are involved.

In particular, there are problems in that as the cable and the connector are left at the observation site for a long time, the corrosion due to moisture such as precipitation, and disability and damage caused by flooding occur or the cutting and damage of the cable and the connector occur by external physical force such as the bird.

Therefore, the need for a cable connector cover that can protect the cable and connectors left outdoors, such as observation sites, is required.

### SUMMARY

An object to be achieved by the present disclosure is to provide a cable connector cover which protects a cable and a connector from an external environment by accommodating the cable and the connector.

Another object to be achieved by the present disclosure is to provide a cable connector cover which prevents moisture introduced thereinto from being introduced into a space accommodating the connector to protect the connector from the moisture.

Yet another object to be achieved by the present disclosure is to provide a cable connector cover in which a bird expeller preventing a bird from sitting is installed on an upper portion to protect a connector and a cable accommodated therein, and a cover itself from the bird.

In order to achieve the object, a cable connector cover according to an exemplary embodiment of the present disclosure includes: a first cover; and a second cover having one sides hinge-connected to each other, and rotating around a hinge axis, and having a space accommodating a cable and a connector therein, and one side of the first cover and one side of the second cover include a first seat portion and a second seat portion having seat holes communicating with the outside and seated with the accommodated cable, respectively when the first cover and the second cover form a space accommodating the cable and the connector, insides of the first cover and the second cover include a first blocking portion and a second blocking portion having blocking holes on which the accommodated cable is seated, respectively when the first cover and the second cover form the space accommodating the cable and the connector, and the first blocking portion and the second blocking portion include a first elastic incision portion and a second elastic incision portion blocking moisture introduced from the seat holes from moving toward the connector, respectively, and protect the cable and the connector accommodated therein from an external environment.

The seat hole includes a fixation member fixing a side portion of the inserted cable, and the fixation member includes a wrinkle portion which protrudes toward an inner side of the seat hole, and having each one end surface pressing and fixing the side portion of the cable.

The incision portion includes a plurality of elastic incision pieces having stretchability, incised radially from a center, and having one end which surrounds and contacts the side portion of the cable.

When each of the first seat portion and the second seat portion is formed in a semicircular shape in which the first seat portion and the second seat portion are symmetric to each other, and the first cover and the second cover form the space accommodating the cable and the connector, the first seat portion and the second seat portion have the seat holes having a circular shape corresponding to the side portion of the cable.

When each of the first blocking portion and the second blocking portion is formed in a semicircular shape or a semi-elliptical shape in which the first blocking portion and the second blocking portion are symmetric to each other, and the first cover and the second cover form the space accommodating the cable and the connector, each of the first blocking portion and the second blocking portion has the blocking hole having a semicircular shape having a diameter larger than a diameter of the seat hole or a semi-elliptical shape having a long axis and a short axis larger than the diameter of the seat hole.

Insides of the first cover and the second cover further include a first blocking wall and a second blocking wall, respectively, the first blocking wall and the second blocking wall form blocking walls partition a connector protection space accommodating the connector and a moisture space in which moisture introduced through the seat hole remains, when the first cover and the second cover form the space accommodating the cable and the connector, and the first blocking wall and the second blocking wall include the first blocking portion and the second blocking portion, respectively.

The connector protection space includes a dehumidification mounting portion on which a replaceable dehumidifying agent is mounted.

The first cover includes a mounting portion which protrudes upward by a predetermined length therein, and the mounting portion includes a mounting hole on which the connector is seated at a center of an upper end portion.

The first cover includes a plurality of mounting portions, the plurality of mounting portions includes mounting holes which protrudes upward with different length, and has different sizes, respectively, and connectors having different sizes are seated on the plurality of mounting portions, respectively.

The first cover and the second cover include fixation means which may fix the first cover and the second cover, and the fixation means includes a fixation jaw and a fixation groove formed on outer peripheral surfaces opened at opposite sides to the hinge axes of the first cover and the second cover, respectively, and the fixation jaw fixes the first cover and the second cover which are inserted into the fixation groove, and pivot.

The first cover or the second cover further includes a tie holder having a tie hole penetrated therein so as to insert a fastening tie, and in the tie holder, the first cover and the second cover form the space accommodating the cable and the connector, and then the fastening tie penetrating the tie hole surrounds and couples the outer peripheral surfaces of the first cover and the second cover to fix the first cover and the second cover, or the fastening tie penetrating the tie hole is coupled to an external structure to fix the cable connector cover to the external structure.

Surfaces where the first cover and the second cover are in contact with each other include a first sealing groove and a second sealing groove inserted to be symmetric to each other, respectively, and a sealing member sealing the space from the outside is installed at the first sealing groove or the second sealing groove.

The first sealing groove and the second sealing groove are inserted along peripheries of the first cover and the second cover, respectively.

In order to achieve the object, according to an exemplary embodiment of the present disclosure, in a cable connector cover forming a space accommodating a cable and a connector coupled to one end of the cable therein to protect the cable and the connector accommodated therein from an external environment, a bird expeller is installed at an upper side of the table connector cover, and the bird expeller includes at least one spike member extended upwards to prevent a bird from sitting on an upper surface.

The bird expeller includes a spike portion including a plurality of spike members, and an insertion portion inserted into the cable connector cover, and the cable connector cover includes an insertion groove portion into which the insertion portion is inserted.

The insertion portion includes an insertion protrusion which protrudes outwards from a lower end portion of the bird expeller by a predetermined length, the insertion groove portion includes an insertion recess groove portion having a shape corresponding to the insertion portion, and inserted into the cable connector cover by a predetermined depth, the inside of the insertion groove portion includes a rotation space in which the insertion portion is rotatable therein, and when the insertion portion is inserted into the rotation space, and then the bird expeller rotates at a predetermined angle, the insertion protrusion is caught on the upper side of the insertion groove portion to prevent the bird expeller from being separated.

The plurality of spike members is coupled to the upper side of the insertion portion, and the plurality of spike members is estranged from each other upwards, respectively.

The plurality of spike members includes a first spike member extended upwards to be perpendicular to a longitudinal direction of the cable connector cover, and a second spike member and a third spike member extended to be estranged from each other upwards based on the first spike member.

The first spike member, the second spike member, and the third spike member are positioned on the same plane as each other.

In order to achieve the object, a cable connector cover according to an exemplary embodiment of the present disclosure includes: a space accommodating a cable and a connector coupled to one end of the cable therein; a seat hole communicating with the outside, and inserted and seated with the cable at one side; and a blocking hole on which a side portion of an inserted cable is seated therein, and the seat hole includes a fixation member fixing a side portion of the inserted cable, the blocking hole includes an elastic incision portion in which a center portion surrounds and contacts the side portion to block moisture introduced from the seat hole from moving toward the connector, the fixation member includes a wrinkle portion which protrudes toward the inner side of the seat hole, and an upper surface of the wrinkle portion includes a plurality of protrusions fixing the side portion of the cable.

According to a cable connector cover according to the present disclosure, there is an effect in that a cable and a connector may be protected from an external environment by accommodating the cable and the connector.

According to a cable connector cover according to the present disclosure, there is an effect in that moisture introduced thereinto is prevented from being introduced into a space accommodating the connector to protect the connector from the moisture.

According to a cable connector cover according to the present disclosure, there is an effect in that a bird expeller preventing a bird from sitting is installed on an upper portion to protect a connector and a cable accommodated therein, and a cover itself from the bird.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a state in which a cable and a connector are accommodated in a cable connector cover according to the present disclosure;

FIG. 2 is a diagram illustrating an inside of the cable connector cover according to the present disclosure;

FIG. 3 is an enlarged diagram of main part ‘A’ illustrated in FIG. 2;

FIG. 4 is an enlarged diagram of main part ‘A’ illustrated in FIG. 2 for showing a first seat portion or a second seat portion according to an exemplary embodiment of the present disclosure;

FIG. 5 is a front view showing a state in which a cable is seated in a seat hole according to an exemplary embodiment of the present disclosure;

FIG. 6 is a diagram illustrating a blocking wall according to the present disclosure;

FIG. 7 is a diagram illustrating an internal state of a first cover according to an exemplary embodiment of the present disclosure;

FIG. 8 is a diagram illustrating a sealing groove and a sealing member according to the present disclosure;

FIG. 9 is a diagram illustrating a bird expeller installed on an upper portion of the cable connector cover according to the present disclosure;

FIGS. 10 and 11 are diagrams illustrating a coupling state of the bird expeller installed on the cable connector cover according to the present disclosure;

FIG. 12 is a diagram illustrating a state in which the bird expeller is inserted into the cable connector cover according to the present disclosure;

FIG. 13 is a diagram illustrating a state in which the bird expeller is inserted into the cable connector cover according to an exemplary embodiment of the present disclosure;

FIG. 14 is a diagram illustrating a bird expeller according to an exemplary embodiment of the present disclosure;

FIG. 15 is a diagram illustrating a state in which a bird expeller including a spike portion is inserted into an insertion groove portion according to an exemplary embodiment of the present disclosure;

FIG. 16 is a diagram illustrating a state in which the bird expeller including the spike portion rotates according to an exemplary embodiment of the present disclosure; and

FIG. 17 is a diagram illustrating a cable connector cover according to an exemplary embodiment of the present disclosure.

### DETAILED DESCRIPTION OF THE EMBODIMENT

Hereinafter, some exemplary embodiments of the present disclosure will be described in detail through exemplary drawings. When reference numerals refer to components of each drawing, it is to be noted that although the same components are illustrated in different drawings, the same components are denoted by the same reference numerals as possible.

Further, in describing the exemplary embodiments of the present disclosure, a detailed explanation of known related configurations and functions may be omitted to avoid interruption of understanding of the exemplary embodiments of the present disclosure.

In describing the components of the exemplary embodiments of the present disclosure, terms including first, second, A, B, (a), (b), and the like may be used. These terms are just intended to distinguish the components from other components, and the terms do not limit the nature, sequence, or order of the components.

In this specification, singular forms include even plural forms unless the context clearly indicates otherwise. It is to be understood that the terms, “comprise” and/or “comprising” used in the specification do not exclude the presence or addition of one or more other components other than stated components.

Hereinafter, the present disclosure is intended to be described in more detail with reference to the accompanying drawings.

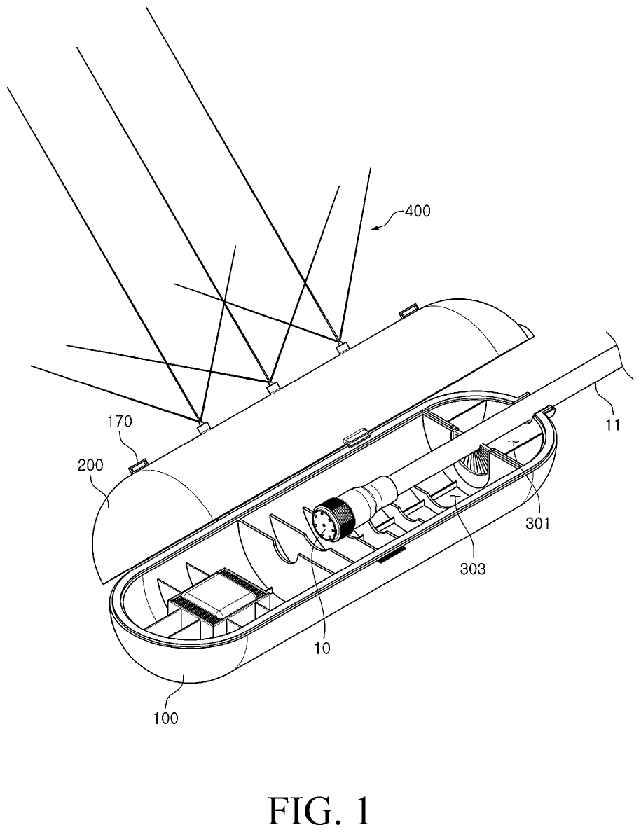

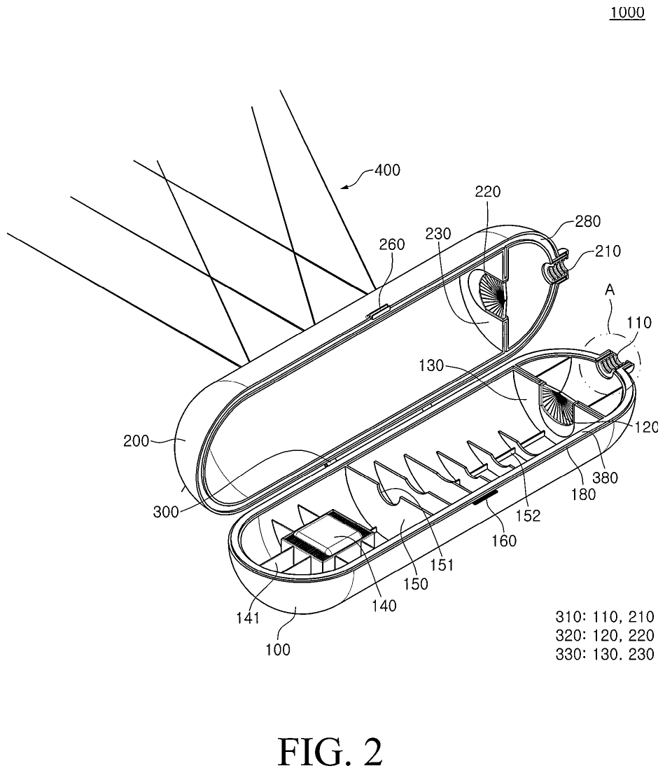

FIG. 1 is a diagram illustrating a state in which a cable 11 and a connector 10 are accommodated in a cable connector cover 1000 according to the present disclosure, and FIG. 2 is a diagram illustrating an inside of the cable connector cover 1000 according to the present disclosure.

Referring to FIGS. 1 and 2, the cable connector cover 1000 according to the present disclosure includes a first cover 100 and a second cover 200 having one sides hinge (300)-coupled to each other, and rotating around a hinge axis, and having a space accommodating the cable 11 and the connector 10 therein.

The first cover 100 and the second cover 200 may be hinge (300)-coupled at sides where they contact each other, and may pivot each other based on the hinge axis. A plurality of hinges 300 may be included in a longitudinal direction of the cable connector cover 1000, or a single hinge 300 may also be extended in the longitudinal direction of the cable connector cover 1000. The longitudinal direction of the cable connector cover 1000 may mean a direction which is the same as a longitudinal direction of the cable 11 accommodated in the cable connector cover 1000.

The first cover 100 and the second cover 200 pivot each other based on the hinge axis, and one surface of the first cover 100 and one surface of the second cover 200 are in contact with each other to form a space accommodating the cable 11 and the connector 10. A first seat portion 110 and a second seat portion 210 are formed at one side of the first cover 100 and one side of the second cover 200, respectively. The first seat portion 110 and the second seat portion 210 have seat holes 110 and 210 which communicate the inside and the outside of the cover with each other when the first cover 100 and the second cover 200 pivot to form the space accommodating the cable 11 and the connector 10. The cable 11 is seated inside the seat holes 110 and 210.

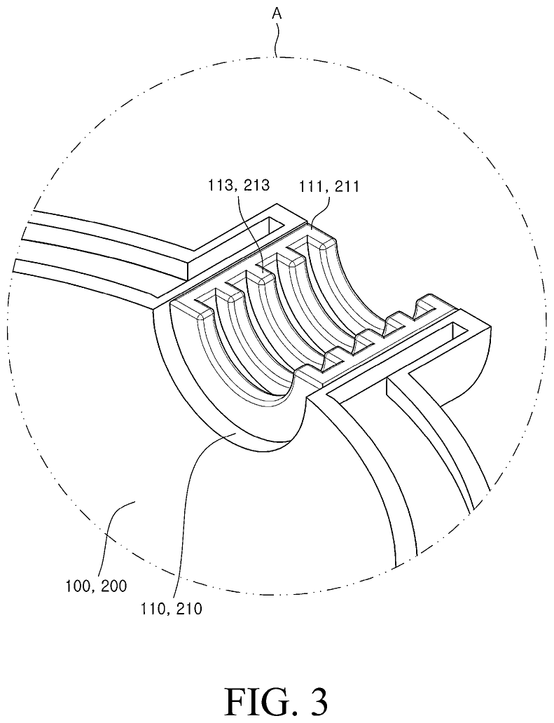

FIG. 3 is an enlarged diagram of main part ‘A’ illustrated in FIG. 2.

Referring to FIG. 3, the first seat portion 110 or the second seat portion 210 include fixation members 111 and 211 that press and fix a side portion of the cable 11, respectively. In this case, the fixation members 111 and 211 coupled onto the first seat portion 110 may be referred to as a first fixation member 111, and the fixation members 111 and 211 coupled onto the second seat portion 210 may be referred to as a second fixation member 211.

Each of the first fixation member 111 and the second fixation member 211 presses and fixes the side portion of the cable 11 accommodated in the cable connector cover 1000 when the first cover 100 and the second cover 200 pivot to form the space accommodating the cable 11 and the connector 10.

The first fixation member 111 and the second fixation member 211 include wrinkle portions 113 and 213 that are formed to protrude toward insides of the seat holes 110 and 210, and have end surfaces which press and fix the side portion of the cable 11, respectively. In this case, the wrinkle portions 113 and 213 formed in the first fixation member 111 may be referred to as a first wrinkle portion 113, and the wrinkle portions 113 and 213 formed in the second fixation member 211 may be referred to as a second wrinkle portion 213. The first wrinkle portion 113 and the second wrinkle portion 213 include a plurality of wrinkles which protrudes upward to have a step.

At this time, a diameter formed by the wrinkle of each of the first and second fixation members 111 and 211 may correspond to a diameter of the cable 11. Accordingly, the cable 11 accommodated in an internal space of the cable connector cover 1000 is fixed by the first fixation member 111 and the second fixation member 211 to be prevented from moving forward and backward.

The first fixation member 111 and the second fixation member 211 may be made of a material having elasticity. Accordingly, even though the diameter formed by the wrinkle of each of the first and second fixation members 111 and 211 is slightly smaller than the diameter of the cable 11, one end surface of each of the first wrinkle portion 113 and the second wrinkle portion 213 presses the side portion of the cable 11 to fix the cable 11.

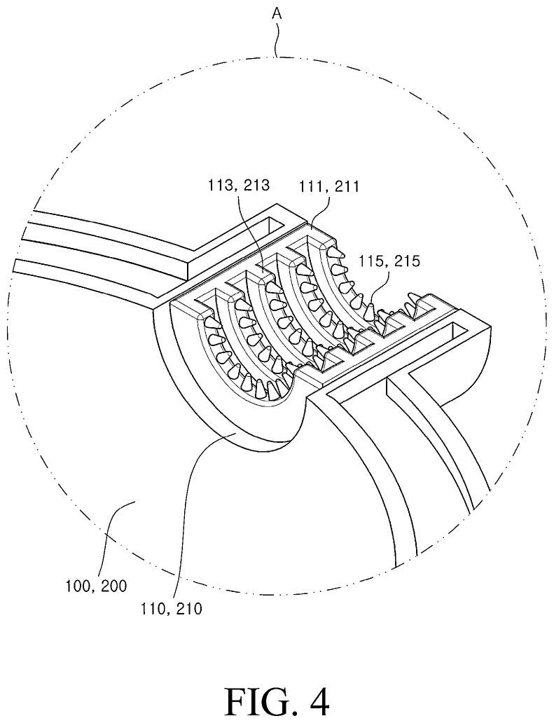

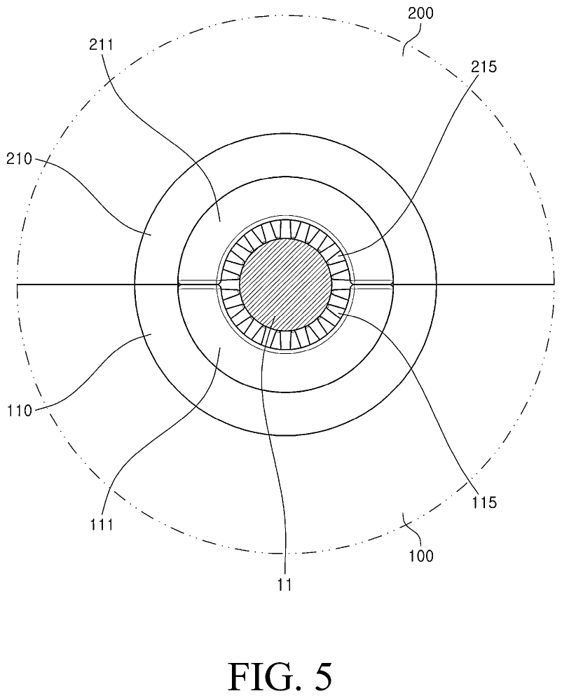

FIG. 4 is an enlarged diagram of main part ‘A’ illustrated in FIG. 2 for showing a first seat portion 110 or a second seat portion 210 according to an exemplary embodiment of the present disclosure, and FIG. 5 is a front view showing a state in which a cable 11 is seated in seat holes 110 and 210 according to an exemplary embodiment of the present disclosure. FIG. 5 illustrates only a part of the seat hole 110 or 210 in order to show a state in which the cable 11 110 and 210 is seated in the seat holes.

When a diameter formed by the wrinkle of each of the first fixation member 111 and the second fixation member 211, i.e., the first wrinkle portion 113 and the second wrinkle portion 213 is larger than the diameter of the cable 11, the cable 11 may not be completely fixed by the first fixation member 111 and the second fixation member 211. According to an exemplary embodiment, referring to FIG. 4, a plurality of protrusions 115 and 215 which protrude toward an inside of the seat holes 110 and 210 by a predetermined length may be formed on an upper surface of the wrinkle of each of the wrinkle portions 113 and 213. The protrusions 115 and 215 include a first protrusion 115 formed at the wrinkle of the first wrinkle portion 113 and a second protrusion 215 formed at the wrinkle of the second wrinkle portion 213. Referring to FIG. 5, even though the diameter of the cable 11 is smaller than the diameter formed by the wrinkle of each of the first fixation member 111 and the second fixation member 211, the protrusions 115 and 215 press the side portion of the cable 11 to fix the cable 11.

The protrusions 115 and 215 may be made of the material having the elasticity and may move forward and backward while being fixed to one end surface of each wrinkle or may be compressed toward the first fixation member 111 and the second fixation member 211 by the cable 11. Accordingly, the protrusions 115 and 215 may flexibly press and fix the side portion of the cable 11 in spite of diameters of various cables 11.

Each of the first seat portion 110 and the second seat portion 210 may be formed in a semicircular shape in which inner sides are symmetric to each other. Accordingly, when the first cover 100 and the second cover 200 pivot around the hinge axis, the first seat portion 110 and the second seat portion 210 may have circular seat holes 110 and 210 therein. The circular seat holes 110 and 210 correspond to a cross section of a general cable 11 having the circular shape.

As illustrated in FIGS. 1 and 2, the cable connector cover 1000 according to the present disclosure includes blocking walls 130 and 230 that block moisture such as rainwater introduced through the seat holes 110 and 210, more specifically, the fixation members 111 and 211 formed at the seat holes 110 and 210. The blocking walls 130 and 230 partition a connector protection space 303 and a moisture space 301. The connector protection space 303 accommodates both the connector 10 and the cable 11. Only the cable 11 is accommodated in the moisture space 301, and moisture introduced through the seat holes 110 and 210 remains in the moisture space 301.

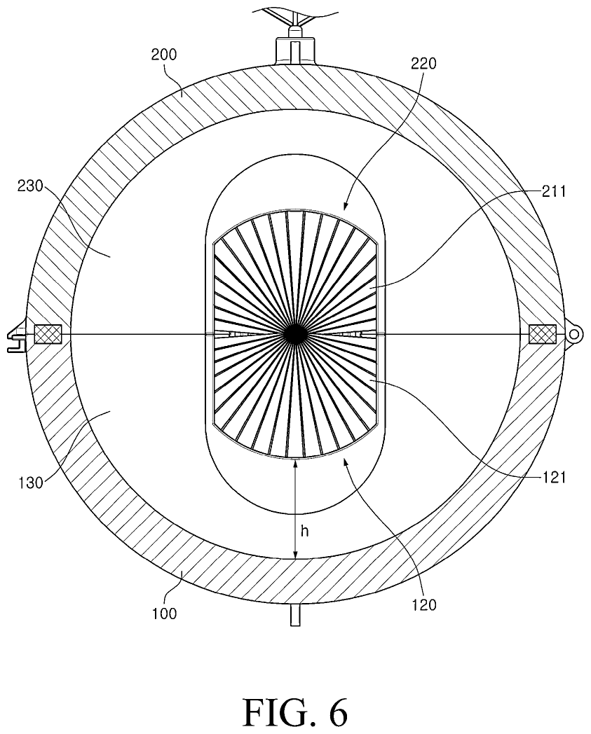

FIG. 6 is a diagram illustrating blocking walls 130 and 230 according to the present disclosure.

The blocking walls 130 and 230 prevent the moisture such as the rainwater introduced through the seat holes 110 and 210 from being introduced into the connector protection space 303 accommodating the connector 10. Referring to FIGS. 1, 2, and 6 jointly, the blocking walls 130 and 230 include a first blocking wall 130 included in the first cover 100 and a second blocking wall 230 included in the second cover 200. When the first cover 100 and the second cover 200 pivot around the hinge axis and are in contact with each other to form the space accommodating the cable 11 and the connector 10, the first blocking wall 130 and the second blocking wall 230 prevent the moisture in the moisture space 301 from being introduced into the connector protection space 303.

The first blocking wall 130 and the second blocking wall 230 include a first blocking portion 120 and a second blocking portion 220 which are seated with the cable 11 and prevent the moisture from being introduced into the connector protection space 303, respectively. The first blocking portion 120 and the second blocking portion 220 have blocking holes 120 and 220 on which the side portion of the cable 11 is seated at a center portion when the first cover 100 and the second cover 200 pivot around the hinge axis to form the space accommodating the cable 11 and the connector 10.

In the first blocking portion 120 and the second blocking portion 220, the blocking holes 120 and 220 are formed, and then the center portion surrounds and contacts the side portion of the cable 11 to block the moisture introduced from the seat holes 110 and 210 from moving toward the connector 10. To this end, the first blocking portion 120 and the second blocking portion 220 include a first elastic incision portion 121 and a second elastic incision portion 221, respectively. The first elastic incision portion 121 is coupled to an inner side of the first blocking portion 120, and the second elastic incision portion 221 is coupled to an inner side of the second blocking portion 220.

Referring to FIG. 6, the first elastic incision portion 121 and the second elastic incision portion 221 include a plurality of elastic incision pieces. In this case, the plurality of elastic incision pieces constituting the first elastic incision portion 121 is referred to as a first elastic incision piece, and the plurality of elastic incision pieces constituting the second elastic incision portion 221 is referred to as a second elastic incision piece. Each of the first elastic incision piece and the second elastic incision piece has elasticity and stretchability. When the first cover 100 and the second cover 200 pivot around the hinge axis to form the space accommodating the cable 11 and the connector 10, the first elastic incision piece and the second incision piece are incised radially from the center of the elastic incision portions 121 and 221, and one end of each of the first elastic incision piece and the second incision piece surrounds and contacts the side portion of the cable 11. Accordingly, the cable 11 is seated on the center portions of the blocking holes 120 and 220.

The cable 11 seated on the center portions of the blocking holes 120 and 220 is supported by elasticity of a plurality of elastic incision pieces. The other end of the elastic incision piece is fixed to the inner sides of the blocking holes 120 and 220, more specifically, the first blocking portion 120 and the second blocking portion 220, so a location of the other end of the elastic incision piece is not changed to prevent the moisture from being introduced into the connector protection space 303. In addition, the blocking holes 120 and 220, more specifically, the first blocking portion 120 and the second blocking portion 220 are formed at locations spaced apart from inner surfaces of the first cover 100 and the second cover 200 by a predetermined height h to more effectively block rainwater, etc., which moves along an inner surface of the cable connector cover 1000.

The first blocking portion 120 and the second blocking portion 220 may be formed in a semicircular shape in which the first blocking portion 120 and the second blocking portion 220 are symmetric to each other or a semi-elliptical shape in which the first blocking portion 120 and the second blocking portion 220 are symmetric to each other in overall, respectively. Accordingly, the first blocking portion 120 and the second blocking portion 220 may form circular or oval blocking holes 120 and 220 when the first cover 100 and the second cover 200 pivot around the hinge axis.

The circular blocking holes 120 and 220 correspond to a cross section of a general cable 11 having the circular shape.

When the blocking holes 120 and 220 are formed in an oval shape, long axes of the blocking holes 120 and 220 are formed toward the first cover 100 and the second cover 200, that is, in a direction from an inner lower end portion of the first cover 100 to an inner upper end portion of the second cover 200, respectively. Accordingly, the cable 11 seated on the center portions of the blocking holes 120 and 220 may be seated at a higher location by the elastic incision piece formed on the long axis. As the cable 11 seated on the center portions of the blocking holes 120 and 220 is seated on a higher location, the cable 11 is prevented from being corroded due to the rainwater, etc. introduced into the moisture space 301.

As illustrated in FIGS. 1 and 2, the first cover 100 includes a mounting portion 150 which protrudes upward by a predetermined length therein. A semicircular mounting hole 151 on which the connector 10 is seated is formed at a center of an upper end portion of the mounting portion 150. The mounting hole 151 may be formed to correspond to a shape of the connector 10.

The mounting portion 150 is included in the connector protection space 303 formed when the first cover 100 and the second cover 200 pivot around the hinge axis. The connector 10 accommodated in the connector protection space 303 is seated on the mounting hole 151.

The mounting hole 151 prevents the seated connector 10 from easily moving within the connector protection space 303. The mounting hole 151 prevents a physical shock which may be applied to the connector 10 by shaking, etc. of the cable connector cover 1000, and the connector 10 is spaced apart from the inner surface of the first cover 100 by a predetermined height to prevent the connector 10 from being corroded due to contacting the rainwater, etc. introduced into the first cover 100.

The first cover 100 includes a plurality of mounting portions 150 having different sizes. The plurality of mounting portions 150 protrudes upward with different lengths and heights. The plurality of mounting portions 150 includes mounting holes 151 having different sizes, respectively. Accordingly, connectors 10 having different sizes may be seated on the plurality of mounting portions 150, respectively.

Each of the plurality of mounting portions 150 is placed inside the first cover 100 so that sizes of the plurality of mounting portions 150 sequentially increase in the connector protection space 303. As an exemplary embodiment, a plurality of different mounting portions 150 which protrudes upward is placed so that lengths of the mounting portions which protrude upward sequentially increase toward a dehumidification mounting portion on which a replaceable dehumidifying agent 140 is mounted, which is to be described below from the blocking wall 130. Sizes of mounting holes 151 which the plurality of mounting portions 150 which protrudes upward with different lengths has, respectively are placed to sequentially increase toward the dehumidification mounting portion from the blocking wall 130. As the sizes of the plurality of mounting portions 150 and the mounting holes 151 provided at the mounting portions 150 sequentially increase toward the dehumidification mounting portion from the blocking wall 130, when connectors 10 having different sizes are seated on any one mounting portion 150 among the plurality of mounting portions 150, the connectors 10 may be more easily seated.

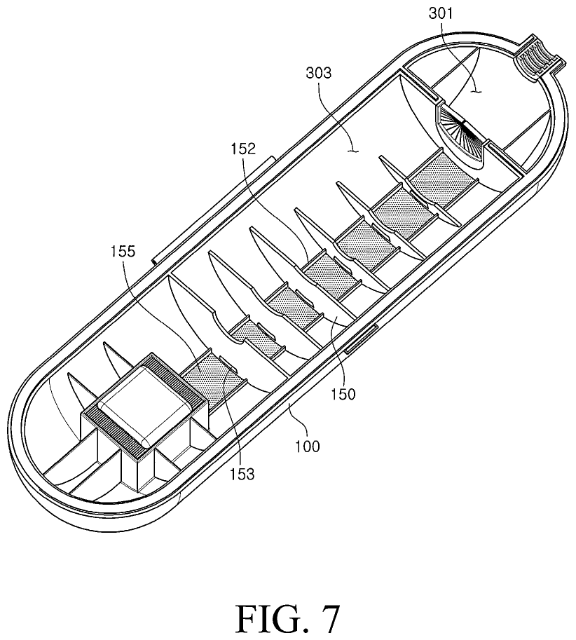

FIG. 7 is a diagram illustrating an internal state of a first cover 100 according to an exemplary embodiment of the present disclosure.

Referring to FIG. 7, an expansion sheet 155 expanded by the introduced rainwater may further included in the inner surface of the first cover 100 according to an exemplary embodiment of the present disclosure. The expansion sheet 155 may include a bonding sheet (not illustrated) bonded onto the inner surface of the first cover 100, and an absorption sheet (not illustrated) made of cotton or nonwoven fabric and absorbing the introduced rainwater.

An absorber (not illustrated) expanded by absorbing a liquid may be further included between the bonding sheet and the absorption sheet. The absorber may contain a super absorbent polymer (SAP). The super absorbent polymer as a synthetic polymer with a function to absorb moisture 500 to 1000 times its own weight has a property expanded when absorbing the moisture. The super absorbent polymer is a white powder type but has a property of absorbing and swelling when the moisture is injected and has a feature of not discharging water easily in spite of receiving an external shock. The super absorbent polymer is generally a white powder, and when the super absorbent polymer enters the water, it instantly absorbs the water, and swells to change into a gel type. In addition, since the super absorbent polymer has a carboxyl group (—COOH), it has an ability to adsorb odors such as ammonia, and when a powder phase is added to the super absorbent polymer, viscosity significantly increases, so the super absorbent polymer changes to a swelled gel.

The expansion sheets 155 may be installed between the blocking walls 130 and 230, and the mounting portion 150, between the mounting portion 150 and the mounting portion 150, and between the mounting portion 150 and a dehumidification mounting portion to be described below, respectively. The blocking walls 130 and 230 and the elastic incision portions 121 and 221 primarily prevent the rainwater, etc. introduced through the seat holes 110 and 210 from being introduced into the connector protection space 303, but when the rainwater, etc. is introduced into the connector protection space 303, the introduced rainwater, etc. is absorbed by the expansion sheet 155 to prevent flooding damage of the connector 10.

The mounting portion 150 further includes an inlet 153 penetrated so that the rainwater, etc. introduced into the connector protection space 303 may flow. The inlet 153 is included in a lower end portion of the mounting portion 150. Accordingly, when the expansion sheet 155 installed between the blocking walls 130 and 230, and the mounting portion 150 absorbs rainwater of a limit or more, rainwater introduced afterward may be absorbed into the subsequent expansion sheet 155 installed between the mounting portions 150 by passing through the inlet 153 of the mounting portion 150 installed closest to the blocking walls 130 and 230.

The first cover 100 further includes a reinforcement member 152 formed between the mounting portions 150. The reinforcement member 152 enhances strengths of the mounting portion 150 and the first cover 100. Further, the reinforcement member 152 supports the expansion sheet 155 to maintain stably fixed state on the inner surface of the first cover 100.

As illustrated in FIGS. 1, 2, and 7 the connector protection space 303 includes the replaceable dehumidifying agent 140. The connector protection space 303 of the first cover 100 includes the dehumidification mounting portion on which the replaceable dehumidification agent 140 is mounted. The dehumidification mounting portion makes the replaceable dehumidifying agent 140 be spaced apart from the inner surface of the first cover 100 by a predetermined length and a predetermined height. The dehumidification mounting portion includes a plurality of dehumidifying agent support member 141. The plurality of dehumidifying agent support members 141 determines the height of the dehumidification mounting portion so that the replaceable dehumidifying agent 140 is positioned at the center of the cable connector cover 1000 where the first cover 100 and the second cover 200 are in contact with each other. Further, the plurality of dehumidifying agent support member 141 prevents the rainwater moving along the inner surface of the first cover 100 from contacting the replaceable dehumidifying agent 140.

As illustrated in FIGS. 1 and 2, the first cover 100 and the second cover 200 include fixation means 160 and 260 which pivot around the hinge axis and fix the first cover 100 and the second cover 200 which are in contact with each other. The first cover 100 and the second cover 200 may be hinge (300)-coupled at sides where they contact each other, and may pivot each other based on the hinge axis. The first cover 100 and the second cover 200 pivot each other based on the hinge axis, and one surface of the first cover 100 and one surface of the second cover 200 are in contact with each other to form the space accommodating the cable 11 and the connector 10.

The fixation means 160 and 260 may be formed at the other side in an opposite direction to the hinge axis. The fixation means 160 and 260 include a fixation jaw 260 and a fixation groove 160 formed on outer peripheral surfaces opened at opposite sides to the hinge axes of the first cover 100 and the second cover 200, respectively. The fixation jaw 260 fixes the first cover 100 and the second cover 200 which are inserted into the fixation groove 160, and pivot around the hinge axis. Locations of the fixation jaw 260 and the fixation groove 160 may be mutually changed, respectively.

The first cover 100 and/or the second cover 200 further include a tie holder 170 having a tie hole penetrated at an inner side so that a fastening tie is enabled to be inserted into the outer peripheral surface. The first cover 100 and/or the second cover 200 include two tie holders 170 on the outer peripheral surfaces of the first cover 100 and the second cover 200, respectively, for example. As illustrated in the drawings, the respective tie holders 170 may be formed to be spaced apart from each other by a predetermined distance on the outer peripheral surface of the lower end portion of the first cover 100 and the outer peripheral surface of the upper end portion of the second cover 200.

In the tie holder 170, while the first cover 100 and the second cover 200 pivot to form the space accommodating the cable 11 and the connector 10, and then the first cover 100 and the second cover 200 are fixed by the fixation jaw 260 and the fixation groove 160, the fastening tie penetrating the tie hole surrounds and couples the outer peripheral surfaces of the first cover 100 and the second cover 200 to more strongly fix the first cover 100 and the second cover 200.

Alternatively, the fastening tie penetrating the tie hole is coupled to an external structure to fix the cable connector cover 1000 accommodating the connector 10 and the cable 11 to the external structure. The fastening tie may include a known cable tie, but is not limited thereto.

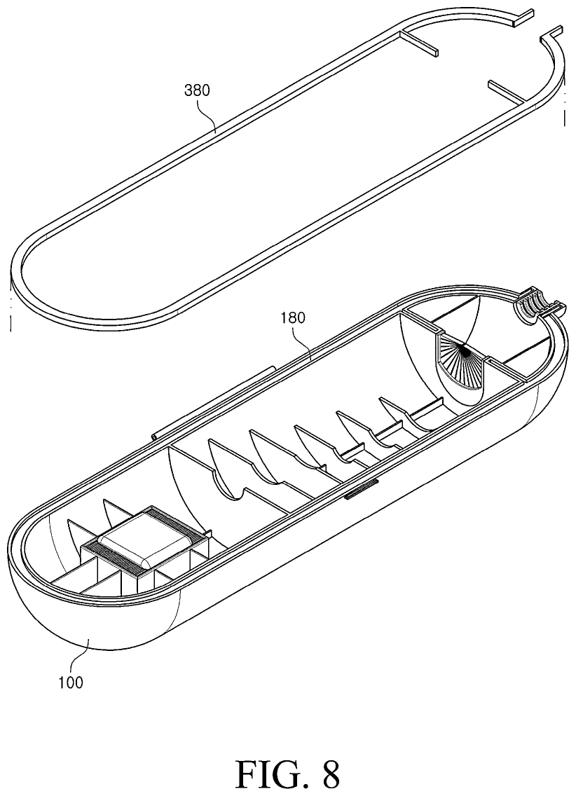

FIG. 8 is a diagram illustrating sealing grooves 180 and 280 and a sealing member 380 according to the present disclosure.

When the first cover 100 and the second cover 200 pivot around the hinge axis to form the space accommodating the cable 11 and the connector 10, a first sealing groove 180 and a second sealing groove 280 inserted to be symmetric to each other are formed on surfaces on which the first cover 100 and the second cover 200 are in contact with each other, respectively as illustrated in FIGS. 1 and 2. In particular, the first sealing groove 180 and the second sealing groove 280 are inserted along peripheries of the first cover 100 and the second cover 200, respectively.

A sealing member 380 that seals the connector protection space 303 and the moisture space 310 from the outside is installed at the first sealing groove 180 and/or the second sealing groove 280. The sealing member 380 has a shape corresponding to the first sealing groove 180 and the second sealing groove 280. The sealing member 380 may be made of a material such as rubber, and prevents the rainwater, etc. from being introduced into the cable connector cover 1000.

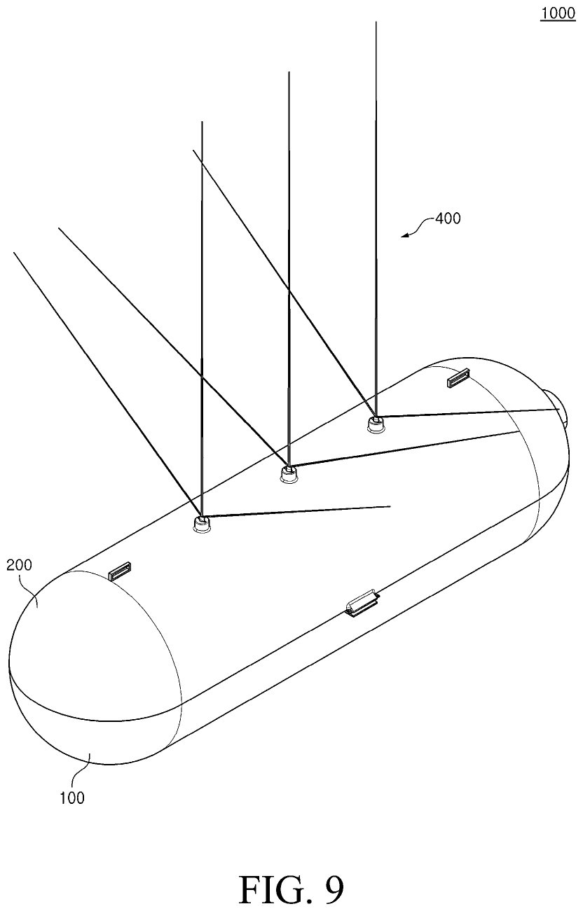

FIG. 9 is a diagram illustrating a bird expeller 400 installed on an upper portion of the cable connector cover 1000 according to the present disclosure.

As described above, the cable connector cover 1000 according to the present disclosure forms the space accommodating the cable 11 and the connector 10 coupled to one end of the cable 11 therein to protect the cable 11 and the connector 10 accommodated therein from the external environment. At this time, the external environment includes not only corrosion of the cable 11 and the connector 10 due to moisture such as precipitation, and failure and damage caused by flooding, but also cutting and damage of the cable 11 and the connector 10 by external physical force such as birds.

The cable connector cover 1000 according to the present disclosure includes a bird expeller 400 installed at an upper side in order to prevent physical damage which may occur by the birds, etc. A plurality of bird expellers 400 may be installed in a row at the upper side of the cable connector cover 1000.

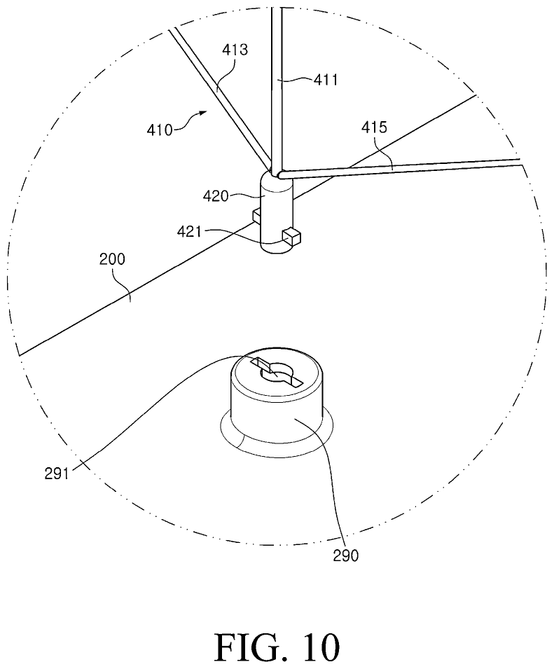

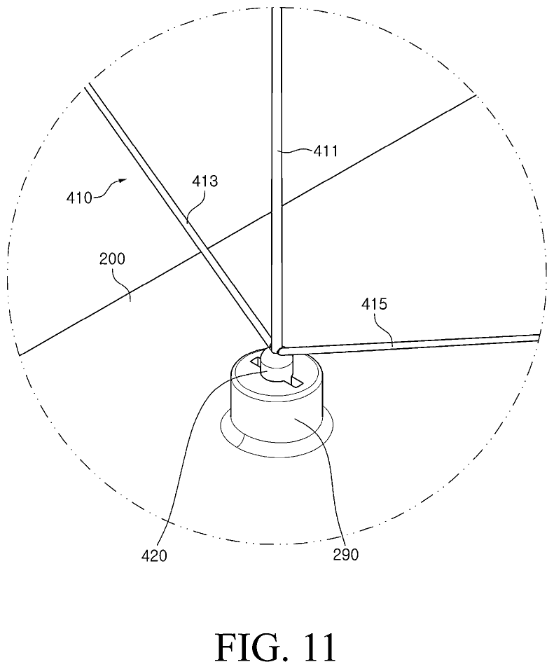

FIGS. 10 and 11 are diagrams illustrating a coupling state of the bird expeller 400 installed on the cable connector cover according to the present disclosure.

Referring to FIG. 10, the bird expeller 400 includes an insertion portion 420 formed at a lower end portion and inserted into the cable connector cover 1000, and a spike portion 410 extended to an upper side from an upper portion of the insertion portion 420.

The spike portion 410 prevents the birds from sitting on the upper surface of the cable connector cover 1000. The spike portion 410 includes a plurality of spike members 411, 413, and 415. The spike portion 410 is coupled to the upper side of the insertion portion 420, and extends upward from the upper side of the insertion portion 420.

The plurality of spike members 411, 413, and 415 is coupled to the upper side of the insertion portion 420. The plurality of spike members 411, 413, and 415 extends upward from the upper side of the insertion portion 420, and in this case, the respective spike members 411, 413, and 415 have a shape in which the spike members 411, 413, and 415 are estranged from each other upwards.

As an exemplary embodiment, the plurality of spike members 411, 413, and 415 includes a first spike member 411 extended upwards on the same axis as a longitudinal direction of the insertion portion 420. That is, the first spike member 411 is extended upward to be perpendicular to the longitudinal direction of the cable connector cover 1000. The plurality of spike members includes a second spike member 413 and a third spike member 415 extended so as to be estranged from each other in opposite directions to each other upwards based on the first spike member 411. In this case, the first spike member 411, the second spike member 413, and the third spike member 415 may be positioned on the same plane as each other. Referring to FIG. 11, the insertion portion 420 is installed in the cable connector cover 1000, more specifically, inserted into the upper surface of the second cover 200 and installed at the upper side of the cable connector cover 1000. The cable connector cover 1000, more specifically, the upper surface of the second cover 200 includes an insertion groove portion 290 into which the insertion portion 420 is inserted.

The insertion portion 420 includes an insertion protrusion 421 which protrudes outwards by a predetermined length. The number of insertion protrusions 421 is not limited. The insertion groove portion 290 has a shape corresponding to the insertion portion 420 including the insertion protrusion 421, and includes an insertion recess groove portion 291 inserted into the cable connector cover 1000, more specifically, the inner side of the second cover 200 by a predetermined depth. The insertion portion 420 is inserted into the insertion groove portion 290 by passing through the insertion recess groove portion 291.

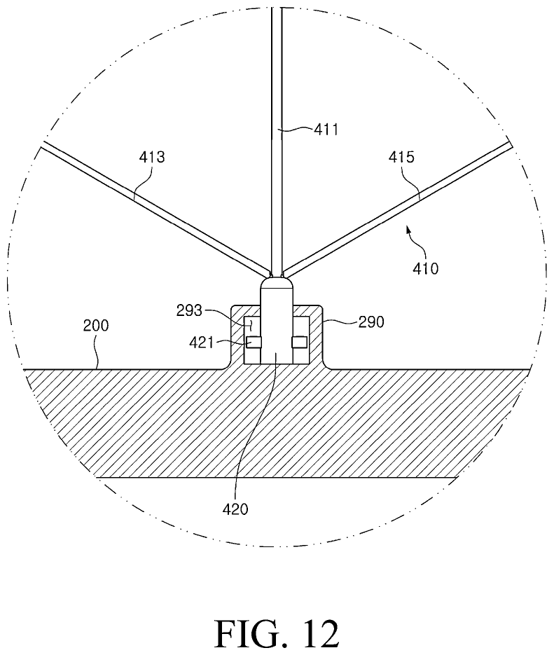

FIG. 12 is a diagram illustrating a state in which the bird expeller 400 is inserted into the cable connector cover 1000 according to the present disclosure.

Referring to FIG. 12, the insertion groove portion 290 includes a rotation space 293 in which the insertion portion 420 may rotate therein.

The insertion portion 420 is inserted into the rotation space 293 of the insertion groove portion 290 by passing through the insertion recess groove portion 291, and then rotates at a predetermined angle, so the insertion protrusion 421 of the insertion portion 420 is caught on the upper side of the insertion groove portion 290. As the insertion protrusion 421 is caught on the upper side of the insertion groove portion 290, the bird expeller 400 is prevented from being separated upwards. That is, the bird expeller 400 is rotatably inserted into the cable connector cover 1000.

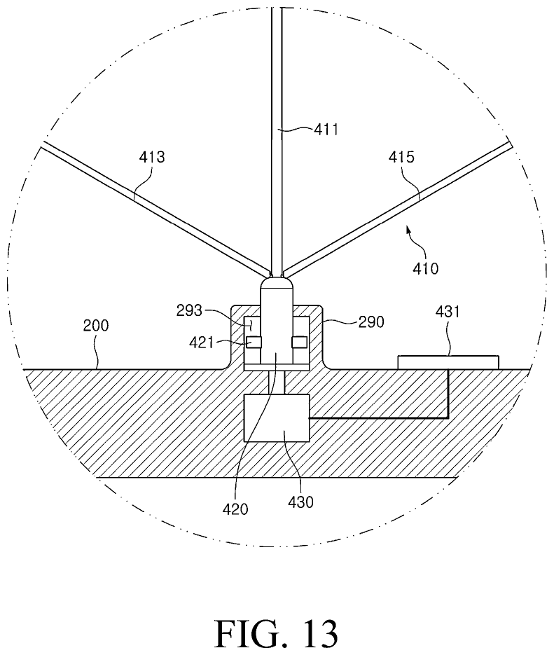

FIG. 13 is a diagram illustrating a state in which the bird expeller 400 is inserted into the cable connector cover 1000 according to an exemplary embodiment of the present disclosure.

According to an exemplary embodiment, referring to FIG. 13, the cable connector cover 1000 of the present disclosure may further include a motor unit 430 rotating the bird expeller 400 and a power supply unit 431 supplying power to the motor unit 430.

The power supply unit 431 may adopt a solar panel and generate electric power by using solar light, and supply the electric power to the motor unit 430. When the solar panel is placed on the cable connector cover 1000, more specifically, the upper surface of the second cover 200, and solar light is irradiated to the solar panel, the solar panel absorbs the solar light to generate the electric power. However, the present disclosure is not limited thereto, but the power supply unit 431 may also receive power from the outside or adopt a replaceable primary battery.

The motor unit 430 may be constituted only by a motor, or a decelerator may be additionally coupled to the motor unit 430. The motor unit 430 transmits rotary force generated by power supplying to the insertion portion 420 to rotate the insertion portion 420 inserted into the insertion groove portion 290. The motor unit 430 and the insertion portion 420 may be coupled in series coaxially, or may be bent in a direction that a driving shaft of the motor unit 430 and the insertion portion 420 cross each other by using an auxiliary member such as a gear to transmit the rotary force.

One side of the insertion portion 420 is coupled to the rotary shaft of the motor unit 430. The insertion portion 420 may rotate in the rotation space 293 in the insertion groove portion 290 by the motor unit 430, and the spike portion 410 may also rotate jointly by the rotation of the insertion portion 420. The bird expeller 400 according to the present disclosure is to prevent the birds from setting on the upper portion of the cable connector cover 1000 through the spike portion 410, and a rotational speed of the spike portion 410 may not be fast.

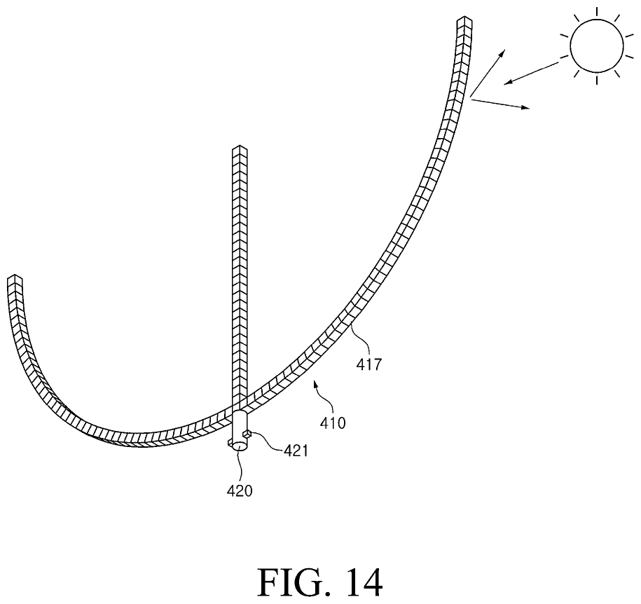

FIG. 14 is a diagram illustrating a bird expeller 400 according to an exemplary embodiment of the present disclosure.

Referring to FIG. 14, the spike portion 410 according to an exemplary embodiment of the present disclosure may include a plurality of reflection units 417 reflecting light to an outer surface. A reflection surface reflecting light is formed on the outer surface of the reflection unit 417. In a spike member 411, the plurality of reflection units 417 may be coupled to have a predetermined shape, and extended upwards. The spike portion 410 including the plurality of reflection units 417 diffusedly reflects the solar light irradiated in various directions to block an approach of the bird. The blocking of the bird approach by the diffused reflection may prevent the bird from sitting on the upper portion of the cable connector cover 1000, and prevent the approach itself.

Each reflection unit 417 may have a planar outer surface other than a curved outer surface. Accordingly, the spike member 411 including the plurality of reflection units 417 has a multi-face shape having a predetermined length. When each the reflection unit 417 has the curved surface, each reflection unit 417 may provide various reflection angles, but point-reflection is made, so the intensity of reflected light is low.

However, the reflection unit 417 according to an exemplary embodiment of the present disclosure has the planar outer surface and achieves surface reflection, and accordingly, the intensity of the reflected light is increased to increase an effect of blocking the approach of the bird. That is, light irradiated in one direction is reflected and traveled by the reflection unit 417, but the reflection surface is formed as a planar surface, so the amount of the reflected light is increased as large as the size of the planar surface, and light is enabled to be reflected more remotely and more strongly than the reflection of the light on the curved surface, thereby blocking the approach of the bird.

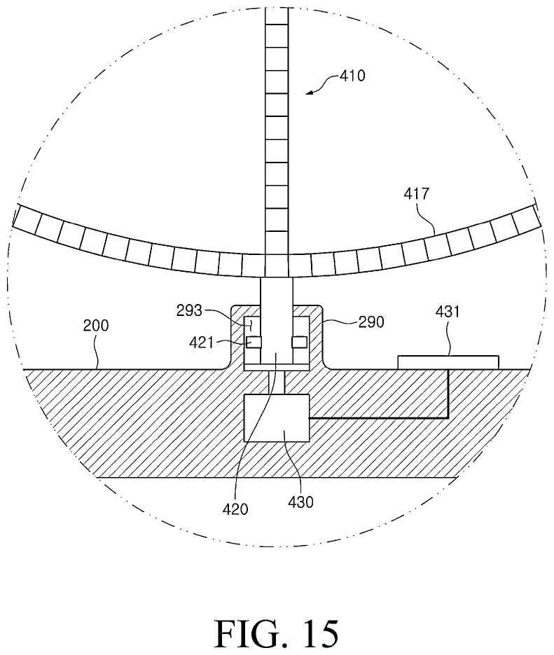

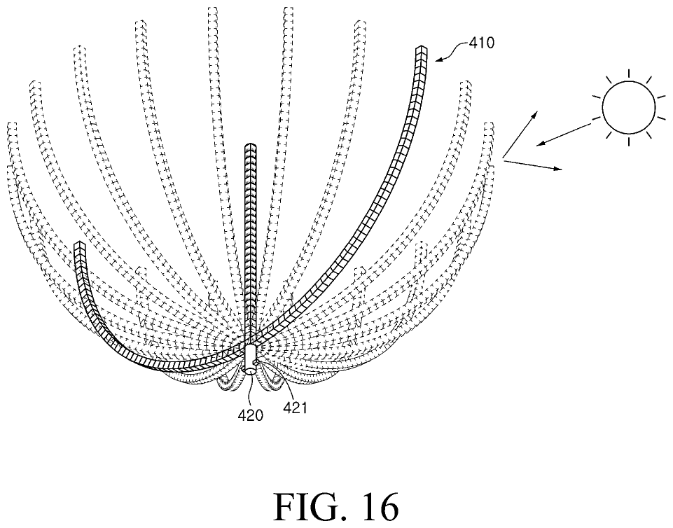

FIG. 15 is a diagram illustrating a state in which a bird expeller 400 including a spike portion 410 is inserted into an insertion groove portion 290 according to an exemplary embodiment of the present disclosure, and FIG. 16 is a diagram illustrating a state in which the bird expeller 400 including the spike portion 410 rotates according to an exemplary embodiment of the present disclosure.

As described above by referring to FIG. 13, the motor unit 430 rotates the bird expeller 400. At this time, as illustrated in FIG. 14, when the spike member 411 of the bird expeller 400 includes the plurality of reflection units 417 reflecting light to the outer surface, the motor unit may also rotate the bird expeller 400 including the reflection unit 417 by referring to FIG. 15. The state of the bird expeller 400 which rotates by the motor unit 430 is illustrated in FIG. 16. In FIG. 16, in order to clearly illustrate a state of the bird expeller 400 which rotates, illustration of the second cover 200, the insertion groove portion 290, the motor unit 430, etc., is omitted.

When the spike members 411 formed by coupling the plurality of reflection units 417 rotate by the motor unit 430, the spike portion 410 of the bird expeller 400 may show a plurality of reflection surfaces in a semicircular shape in overall. The spike unit 410 which rotates may cause diffuse reflection more effectively.

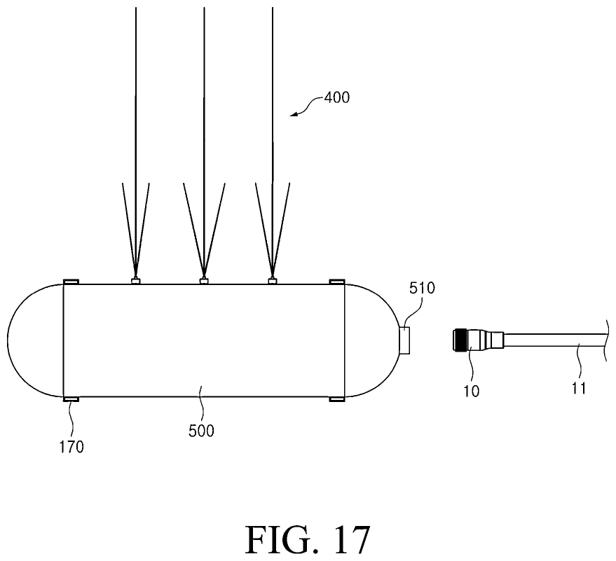

FIG. 17 is a diagram illustrating a cable connector cover 1000 according to an exemplary embodiment of the present disclosure.

Referring to FIG. 17, the cable connector cover 1000 according to an exemplary embodiment of the present disclosure is configured by an integrated cover 500 to protect the cable 11 and the connector 10 accommodated therein from the external environment.

As described above, an inside of the integrated cover 500 includes the moisture space 301 which is the space accommodating the cable 11 and the connector 10 connected to one end of the cable 11, the blocking walls 130 and 230 partitioning the connector protection space 303, the blocking holes 120 and 220 included in the blocking walls 130 and 230, the elastic incision portions 121 and 221, and the like. The integrated cover 500 includes a seat hole 510 which is in communication with the outside, and inserted and seated with the cable 11 and the connector 10 at one side thereof. The seat hole 510 includes fixation members 111 and 211 that press and fix the side portion of the inserted cable 11 therein.

That is, the integrated cover 500 includes all components described above. When the cable connector cover 1000 according to the present disclosure includes the integrated cover 500, the connector 10 and the cable 11 are inserted into the integrated cover 500 through the seat hole 510. At this time, it is preferable that a diameter of the seat hole 510, more specifically, diameters of the fixation members 111 and 211 correspond to diameters of the connector 10 and the cable 11, in particular, the diameter of the connector 10 or slightly larger than the diameter of the connector 10.

The diameter of the cable 11 is generally smaller than the diameter of the connector 10. Accordingly, since the diameter of the seat hole 510, specifically, the cable 11 seated on the fixation members 111 and 211 is smaller than a diameter formed by the wrinkle portions 113 and 213 of the fixation members 111 and 211, it is difficult that the fixation members 111 and 211 perfectly press and fix the side portion of the cable 11.

Therefore, when the cable connector cover 1000 includes the integrated cover 500, a plurality of protrusion 115 and 215 which protrudes toward the inner sides of the seat holes 110 and 210 by a predetermined length may be formed on an upper surface of the wrinkle of each of the wrinkle portions 113 and 213 as described by referring to FIG. 4. Referring to FIG. 5, even though the diameter of the cable 11 is smaller than the diameter formed by the wrinkle of each of the fixation members 111 and 211, the protrusions 115 and 215 press the side portion of the cable 11 to fix the cable 11.

A protection scope of the present disclosure is not limited to disclosure and expression of the exemplary embodiment explicitly described above. Further, it is additionally mentioned once again that the protection scope of the present disclosure cannot be limited due to apparent change or substitution in a technical field to which the present disclosure belongs.

What is claimed is:

1. A cable connector cover comprising:
a first cover; and a second cover having one sides hinge-connected to each other, and rotating around a hinge axis, and having a space accommodating a cable and a connector therein,
wherein the one side of the first cover and the one side of the second cover include a first seat portion and a second seat portion having seat holes communicating with an outside and seated with the accommodated cable, respectively when the first cover and the second cover form a space accommodating the cable and the connector,
insides of the first cover and the second cover include a first blocking portion and a second blocking portion having blocking holes on which the accommodated cable is seated, respectively, when the first cover and the second cover form the space accommodating the cable and the connector, and
the first blocking portion and the second blocking portion include a first elastic incision portion and a second elastic incision portion blocking moisture introduced from the seat holes from moving toward the connector, respectively, and protect the cable and the connector accommodated therein from an external environment.

2. The cable connector cover of claim 1, wherein the seat hole includes a fixation member fixing a side portion of the cable, and
the fixation member includes a wrinkle portion which protrudes toward an inner side of the seat hole, and having each one end surface pressing and fixing the side portion of the cable.

3. The cable connector cover of claim 1, wherein each of the first elastic incision portion and the second elastic incision portion includes a plurality of elastic incision pieces having stretchability, incised radially from a center, and having one end which surrounds and contacts the side portion of the cable.

4. The cable connector cover of claim 1, wherein when each of the first seat portion and the second seat portion is formed in a semicircular shape in which the first seat portion and the second seat portion are symmetric to each other, and the first cover and the second cover form the space accommodating the cable and the connector, the first seat portion and the second seat portion have the seat holes having a circular shape corresponding to the side portion of the cable.

5. The cable connector cover of claim 4, wherein when each of the first blocking portion and the second blocking portion is formed in a semicircular shape or a semi-elliptical shape in which the first blocking portion and the second blocking portion are symmetric to each other, and the first cover and the second cover form the space accommodating the cable and the connector, each of the first blocking portion and the second blocking portion has the blocking hole having a semicircular shape having a diameter larger than a diameter of the seat hole or a semi-elliptical shape having a long axis and a short axis larger than the diameter of the seat hole.

6. The cable connector cover of claim 5, wherein the insides of the first cover and the second cover further include a first blocking wall and a second blocking wall, respectively,
the first blocking wall and the second blocking wall form blocking walls partition a connector protection space accommodating the connector and a moisture space in which moisture introduced through the seat hole remains, when the first cover and the second cover form the space accommodating the cable and the connector, and
the first blocking wall and the second blocking wall include the first blocking portion and the second blocking portion, respectively.

7. The cable connector cover of claim 6, wherein the connector protection space includes a dehumidification mounting portion on which a replaceable dehumidifying agent is mounted.

8. The cable connector cover of claim 1, wherein the first cover includes a mounting portion which protrudes upward by a predetermined length therein, and
a mounting hole on which the connector is seated is provided at a center of an upper end portion of the mounting portion.

9. The cable connector cover of claim 8, wherein the first cover includes a plurality of mounting portions,
the plurality of mounting portions includes mounting holes which protrude upward with different lengths, and have different sizes, respectively, and
the connectors having different sizes are seated on the plurality of mounting portions, respectively.

10. The cable connector cover of claim 1, wherein the first cover and the second cover include fixation means which may fix the first cover and the second cover, and
the fixation means includes a fixation jaw and a fixation groove formed on outer peripheral surfaces opened at opposite sides to the hinge axes of the first cover and the second cover, respectively, and the fixation jaw fixes the first cover and the second cover which are inserted into the fixation groove, and pivot.

11. The cable connector cover of claim 1, wherein the first cover or the second cover further includes a tie holder having a tie hole penetrated therein so as to insert a fastening tie, and
in the tie holder, the first cover and the second cover form the space accommodating the cable and the connector, and then the fastening tie penetrating the tie hole surrounds and couples outer peripheral surfaces of the first cover and the second cover to fix the first cover and the second cover, or the fastening tie penetrating the tie hole is coupled to an external structure to fix the cable connector cover to the external structure.

12. The cable connector cover of claim 1, wherein surfaces where the first cover and the second cover are in contact with each other include a first sealing groove and a second sealing groove inserted to be symmetric to each other, respectively, and
a sealing member sealing the space from the outside is installed at the first sealing groove or the second sealing groove.

13. The cable connector cover of claim 12, wherein the first sealing groove and the second sealing groove are inserted along peripheries of the first cover and the second cover, respectively.

14. A cable connector cover forming a space accommodating a cable and a connector coupled to one end of the cable therein to protect the cable and the connector accommodated therein from an external environment, wherein a bird expeller is installed at an upper side of the table connector cover, and
the bird expeller includes at least one spike member extended upwards to prevent a bird from sitting on an upper surface.

15. The cable connector cover of claim 14, wherein the bird expeller includes
a spike portion including a plurality of spike members, and
an insertion portion inserted into the cable connector cover, and
the cable connector cover includes an insertion groove portion into which the insertion portion is inserted.

16. The cable connector cover of claim 15, wherein the insertion portion includes an insertion protrusion which protrudes outwards from a lower end portion of the bird expeller by a predetermined length,
the insertion groove portion includes an insertion recess groove portion having a shape corresponding to the insertion portion, and inserted into the cable connector cover by a predetermined depth,
an inside of the insertion groove portion includes a rotation space in which the insertion portion is rotatable therein, and
when the insertion portion is inserted into the rotation space, and then the bird expeller rotates at a predetermined angle, the insertion protrusion is caught on an upper side of the insertion groove portion to prevent the bird expeller from being separated.

17. The cable connector cover of claim 15, wherein the plurality of spike members is coupled to an upper side of the insertion portion, and
the plurality of spike members is estranged from each other upwards, respectively.

18. The cable connector cover of claim 17, wherein the plurality of spike members includes a first spike member extended upwards to be perpendicular to a longitudinal direction of the cable connector cover, and
a second spike member and a third spike member extended to be estranged from each other upwards based on the first spike member.

19. The cable connector cover of claim 18, wherein the first spike member, the second spike member, and the third spike member are positioned on the same plane as each other.
